(19) United States
(12) Patent Application Publication
(10) Pub. No.: US 2003/0076935 A1
(43) Pub. Date: Apr. 24, 2003

(54) Face-to-face rendezvous method and system

(76) Inventor: Peter J Gosney, Victoria (AU)

Correspondence Address: LARSON & TAYLOR, PLC, 1199 NORTH FAIRFAX STREET, SUITE 900, ALEXANDRIA, VA, 22314, US

(21) Appl. No.: 10/221,794

(22) PCT Filed: May 31, 2001
(86) PCT No.: PCT/AU01/00646

(30) Foreign Application Priority Data
Jun. 2, 2000 (AU) PQ7930
Sep. 27, 2000 (AU) PR0410

(51) Int. Cl. H04M 1/64

(52) U.S. Cl. 379/88.22

(57) ABSTRACT

There is provided a method and a system to permit face-to-face rendezvous which enables one person to announce the desire to rendezvous with another person so that the another person can be alerted to the desire and then make face-to-face contact. Information identifying the one person is input into a first input station (3) and that information is then stored in said first input station. The input station is then activated to retrieve the stored information and to transfer that information to a receiving station (15) together with first station input station ID data. The another person is then alerted to the information and the ID data by the receiving station (15). An acknowledgement signal is provided to the first input station (3) so that said one person can be made aware that the information has been received. A plurality of second input stations (13, 18) are provided at other locations so that when the first person is at one of the second stations that person can input further information identifying presence at the second input station (13, 18) so that the another person can be advised that the one person is at a particular one of the second input stations (13, 18). The system and method facilitates rendezvous particularly at airports and other large public transportation establishments. A further input station can be provided at a point of departure in a transportation system thereby alerting the another person to the fact that the one person is at the point of departure. This will pre-prepare the another person for the expected arrival having regard to the transit time between the point of departure and the point of arrival.

### FIELD OF THE INVENTION

This invention relates to a face-to-face rendezvous method and system and relates particularly but not exclusively to such for use at airports to enable a traveller to make contact with a transport provider such as a specialised taxi company for a face-to-face meeting—a taxi pick-up rendezvous.

### DESCRIPTION OF PRIOR ART

Hitherto at large airports it has been recognised that the provision of ground transport to passengers has many problems. In large airports such as New York's JFK airport operators admit to failure rates of up to 50% in respect of placed orders for passengers and actual pick-up of passengers. Generally, a passenger may require specialised ground transport as distinct from a conventional taxi. This obviates the need to stand in long queues for extended periods of time waiting one's turn.

There is also the problem that a passenger often has to single handedly collect luggage from the airport carousel and move it to the taxi rank.

In an embodiment of the present system, dedicated transportation services can be provided and moreover, a request can be made for a rendezvous at the airport luggage carousel. In that instance, the passenger is able to be assisted in the carrying of luggage to the transportation.

### OBJECT AND STATEMENTS OF THE INVENTION

It is therefore an object of the present invention to attempt to provide a face-to-face rendezvous method and system which will alleviate one or more of the problems of the prior art.

Certain embodiments have application in the provision of dedicated transport services. Other embodiments can be used for different rendezvous purposes.

According to a first broad aspect of the present invention there is provided a face-to-face rendezvous method enabling one person to announce the desire to rendezvous with another person so that said another person can be alerted to the desire and then make face-to-face contact,

said method including inputting information identifying said one person to a first input station, storing that information in a store in said first input station, activating said first input station to retrieve that stored information and to transmit that information to a receiving station together with first input station ID data, having said another person alerted to that information and the ID data by said receiving station thereby signifying the desire to rendezvous and the location of the one person by association of the ID data with known input station location, providing an acknowledging signal to the first input station so that said one person can be made aware that the information has been received, having a second input station in closer proximity than the first input station to a pre-established point of rendezvous, inputting information by said one person identifying presence of said one person at said second station, said second station transmitting that information to said receiving station together with second input station ID data so said another person can be advised of said one person at said second input stations the ID data from the particular second input station identifying the location of the one person by association of the second input station ID data with known input station location, and

finally, having said another person then make face-to-face contact with said one person.

It is particularly preferred that each of said second input stations be similar to said first input station in that each also contains a store for storing said information and wherein said information can be retrieved from said store for transmitting to said receiving station.

It is further preferred that there is included a third input station located at a first location remote from a second location where said first input station is located, said method including a user inputting information identifying said one person and indicating their future arrival at a first input station thereby signifying the desire of the one person rendezvous at a future time, alerting said another person to signify the desire to rendezvous at a future time to thereby prepare said another person to rendezvous at said future time, and providing an acknowledging signal to the third input station so that said one person can be made aware that said another person has been alerted.

According to a further broad aspect of the present invention there is provided a third input station located at a location remote from where said first input station and said second input station are located, said method including a user inputting information identifying said one person and indicating their likely future arrival at a first or second input station thereby signifying the desire of the one person to rendezvous at a future time, alerting said another person to signify the desire to rendezvous at a future time to thereby prepare said another person to rendezvous at said future time, and providing an acknowledging signal to the third input station so that said one person can be made aware that said another person has been alerted.

It is particularly preferred that said receiving station be an intermediary to transmitting the information to the another person.

It is particularly preferred that said information is processed at said receiving station to identify said one person from the received information and to check a profile for that one person to determine particular preference or pre-arranged rendezvous requirements for said one person and to, in turn, act in respect thereto to effect those preferences or requirements.

It is further preferred that there is included a third input station located at a first location remote from a second location where said first input station is located, whereby said one person can input information identifying said one person and indicating their future arrival at said second location thereby signifying the desire of the one person rendezvous at said future time, alerting said another person to signify the desire to rendezvous at a future time to thereby prepare said another person to rendezvous at said future time, and providing an acknowledging signal to the third input station so that said one person can be made aware that said another person has been alerted.

Throughout this specification the term “input station ID data” is to embrace a unique set of data which identifies the input station. This may be transmitted from the input station itself or it may be caller ID data transmitted in the communication system itself such as caller ID data available in recent telecommunication systems or extension ID in the case of system implement through a central switchboard.

### BRIEF DESCRIPTION OF THE DRAWINGS

In order that the invention can be more clearly ascertained preferred examples for use in providing specialised ground transport at an airport will now be described wherein:

FIG. 1 is a block schematic diagram showing a total system interconnected at an airport and interfacing with ground transport;

FIG. 2 is a functional flow diagram of software functionality;

FIG. 3 is a front view of a first input station through which a passenger can input identifying information so that it can be transmitted to a receiving station;

FIG. 4 is a view similar to that of FIG. 3 showing a second input station;

FIG. 5 is a view similar to that of FIG. 4 showing a still further second input station;

FIG. 6 is a chart showing types of displays in a display on the input stations of FIGS. 3, 4 and 5;

FIG. 7 shows a different ordering station; and

FIGS. 8a and 8b show a sample ordering folder.

### DETAILED DESCRIPTION OF THE PREFERRED EMBODIMENTS

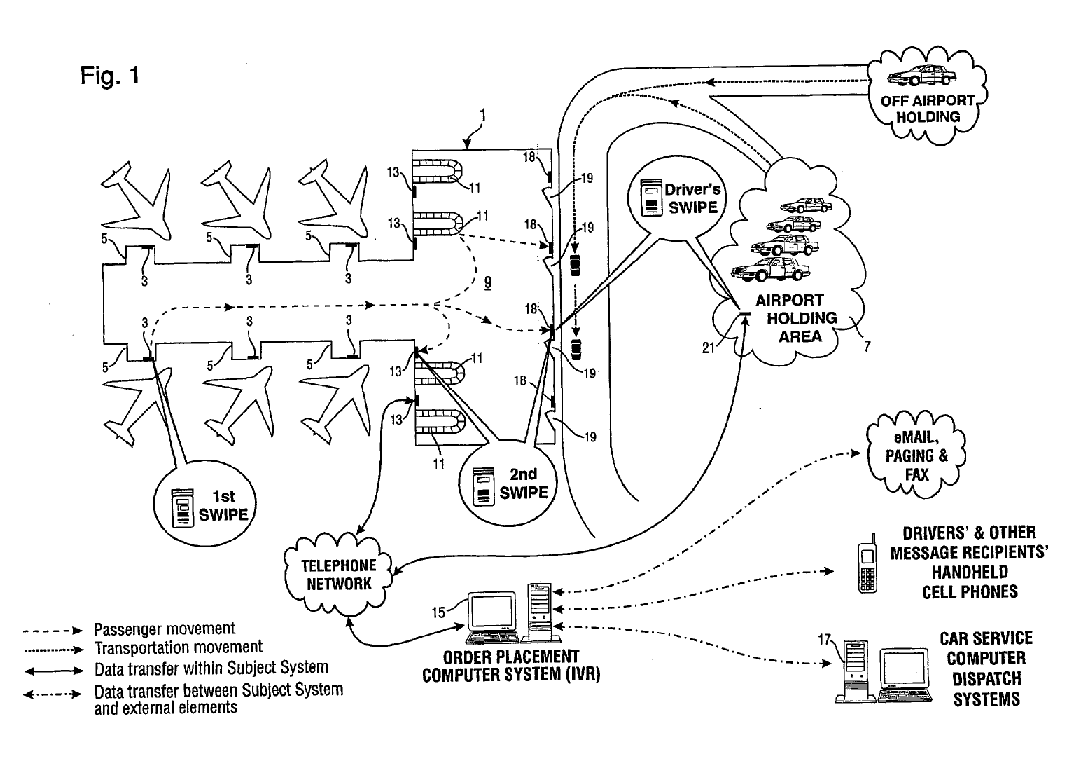

Referring firstly to FIG. 1 there is shown a total system fitted with first input stations 3 at locations such as the arrival gates 5 of an airport terminal 1. Typically, the first input stations 3 are mounted at some convenient position such as immediately inside the airport terminal 1 at each of the gates 5. Suitable signage can alert passengers to the presence of the first input stations 3 so as to avoid passenger confusion as to the location of the input stations 3.

As a passenger departs the plane and passes an arrival gate 5, the passenger can approach a first input station 3 and input information to identify that person by swiping an identification card or by otherwise entering information into the first input station 3. This information can be dispatched to the ground transport provider to alert the ground transport provider that a passenger requires to make rendezvous. It does not necessarily, but it may, indicate to the ground transport driver that the driver should then move to a kerb side pick-up area at the front of the airport terminal 1. Typically, the ground transport can be waiting at an airport holding area 7 or some other suitable location.

The passenger, after inputting information to the first input station 3 then either walks directly to the kerb side for a pick-up or goes to the carousel area 9 for baggage collection from one of many carousels 11.

A plurality of second input stations 13 are provided at the carousel area 9, and further second input stations 18 are provided at the exit gates 19 where the ground transport is able to pick up the passenger. The passenger can then input information into the appropriate one of the input stations 13 or 18 to again identify that person and the desire for the ground transport to actually be present for transportation service. The second input stations 13 and 18 are adjacent respective carousels 11 and exit gates 19. Thus, by swiping the appropriate second input stations 13 and 18 the particular location of the passenger can be determined.

In the case of inputting information such as by a passenger swiping a second input station 13 it will signify that the passenger requires personal face-to-face rendezvous at a particular carousel 11 in order that the passenger can be assisted with luggage.

In the case of a passenger swiping a second input station 18 it will signify that the passenger has either walked past the carousels 11 and proceeded directly to an exit gate 19, or has personally collected the baggage from the carousel 11 and has proceeded to the exit gate 19. In both cases the particular second input station 18 swiped will indicate the particular gate 19 at which the person requires face-to-face rendezvous.

Each time the passenger inputs information either to the first input station 3 or a second input station 13, a connection is made through a communication medium such as a conventional PSTN land-line or by radio to transmit that information to a computerised order placement system 15. Input terminal ID data unique to each input station is also transmitted to the computerised order placement system is, and this ID data enables the location of the passenger to be determined by association of the ID data with the known location of the particular input station. The computerised order placement system is therefore a “receiving station”. The computer placement system 15 can be operated through software to identify the particular passenger and the passengers location from the received information and the received ID data, and check a profile of that passenger to determine particular preferences or pre-arranged rendezvous requirements. This information can then be dispatched from the computer placement system 15 directly to the ground transport driver or, in turn, relayed to a dispatch computer system 17 so it can then, in turn, be relayed to the ground transport driver.

Typically, the first input station 3 and second input stations 13 and 18 are interconnected with an interactive voice response computer system which recognises DTMF tones generated at each of the input stations and representative of the input information and the input station ID data. The computer system is connected to a telephone system within the airport terminal 1. The telephone system may be part of the airport communication infrastructure or it may be a dedicated service provided directly to the computer placement system 15.

The passenger can input the information identifying the passenger in any form. The passenger is typically provided with a plastic card with a magnetic stripe with encoded data embedded identifying the passenger. This can be a card issued for the dedicated purpose of use in this system. It can, however, be any standard credit card which may be known to the system or unknown. If the card is a credit card or other card known to the system, information can be extracted from the card which will then enable the placement computer system 15 to extract the card holders relevant pick-up preference information.

The driver of the ground transportation can receive information from the computer placement system 15 via a dispatch computer system 17 such as a computerised mobile data dispatch system used in taxi fleets or via a mobile telephone system or even a pager system or some other communication system.

When the passenger has a first swipe through the first input station 3 the system will provide “an early warning” to the ground transportation provider. In the case of fleet managers it will enable them to marshal resources and drivers to position themselves best for timely pick-up or rendezvous.

The passenger on exiting the plane and passing through the gate 5 simply swipes the card through the first input station 3 so that information concerning the passenger can be extracted therefrom and used in the system.

Typically, the first input station 3 has user activatable keys, one of which can be used to signal a passengers desire to be picked up at the kerb side of the terminal 1. This would occur for instance where a passenger has no baggage to collect from the carousels 11 and merely requires to walk from the arrival gate 5 to the kerb side. Another key can be used to request the driver of the ground transport to enter the terminal 1 and assist the passenger with collection of luggage from a carousel 11.

When the passenger swipes the card through the second input station 13 either at the carousel 11 or at the exit gate 19 of the terminal 1,the system will then signify to the driver of the ground transport as to the exact position of the passenger.

The system enables pre-arrangements to be made for collection such as;

1. passenger always requires to be met at carousel or

2. passenger requires a particular limousine or

3. other requirements.

Thus, when using a dedicated card for this service, pre-arrangement information such as pick-up preference information can be stored at the order placement computer system 15 so that when the passenger swipes the card at the first input station 3 or a second input station 13, the driver of the ground transportation can be alerted to the particular requirements if not already aware of those requirements. If a pre-arrangement is made then it is assumed that the ground transportation will be waiting for that particular passenger. Thus, the swipe at the first input station 3 alerts the driver that the passenger has arrived at the arrival gate 5 of the airport.

It is particularly preferred that the second input stations 13 at the carousels 11 and the second input stations 18 at the exit gates 19 be identified differently within the system by the ID data. In this way, when the passenger swipes the second input station means 13 at the carousels 11 or the second input station 18 at the exit gates 19 a unique signal representative of that position of the passenger can be provided into the system so that it can be relayed to the ground transportation driver to signify the precise location of the passenger at one of the carousels 11 or one of the exit gates 19.

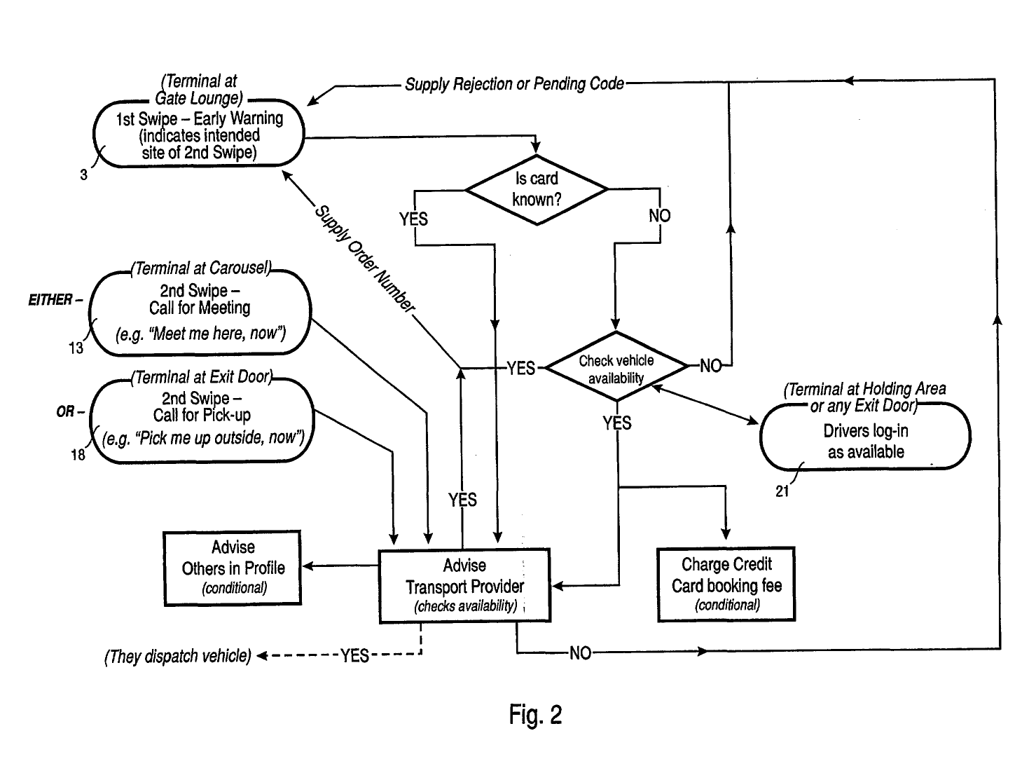

Referring now to FIG. 2 there is shown a functional software flow diagram of the processing steps involved in the software within the system. Implementation of the particular software can be undertaken by a suitable programmer knowing the functionality required.

FIG. 2 shows that a first swipe of an ID card can be made at the first input station 3. When this information is received by the order placement computer system 15, software is invoked to determine if the card is known. If the card is known then the transport provider is informed. This alerts the driver that the passenger has reached the airport arrival gates 5. Simultaneously, the information is checked against a profile for the particular passenger and if a match is found then pick-up preferences are invoked. For example the particular hire car may be a limousine as distinct from a sedan car. It may be a vehicle for an incapacitated person and the like. Messages may be relayed to the passenger's home or office to announce the arrival at the airport. Simultaneously with that process, the order placement computer system 15 returns an order number or other code to the first input station 3 so it can be displayed and the passenger made aware of that number or code. That number or code will be used later to identify the particular driver or the vehicle.

If the card is unknown then a check of availability of a vehicle is then made. It should be appreciated that if the card is known, that a vehicle is expected to be at the airport because the passenger would have made prior arrangements for the vehicle to be at the airport. If the card is unknown then a check must be made if a vehicle is available. If a vehicle is available then the process follows the process described when the card is known. If no vehicle is available then a rejection code is sent back to the first input station 3 to alert the passenger that a vehicle is not available and that perhaps they should try again at the second station input means 13 or 18.

If a vehicle is available then a credit charge is made on the card. Typically the card swiped will be a credit card. It should also be noted that as drivers arrive at the airport holding area 7 they can swipe their own cards into a driver's input station means 21 shown in FIG. 1. This will log into the system that a vehicle is available for use by a passenger when the passenger's swipe card is unknown.

As the passenger arrives either at the second input station means 13 or the second input station means 18 their card is swiped once again and a further check is made to see if a vehicle is available. If a vehicle is available then it is dispatched from the holding area so there can be an appropriate rendezvous. If a vehicle is still not available then a rejection code is provided back to the appropriate one of the second station input means 13 or 18. If a vehicle is available the order number or code is again repeated and the passenger is then required to remember that number or code as that number or code will be carried either by the driver when he enters the terminal and approaches the respective carousel 11, or it will be displayed in the vehicle when the vehicle approaches the appropriate gate 19. This will identify the driver or vehicle to the passenger.

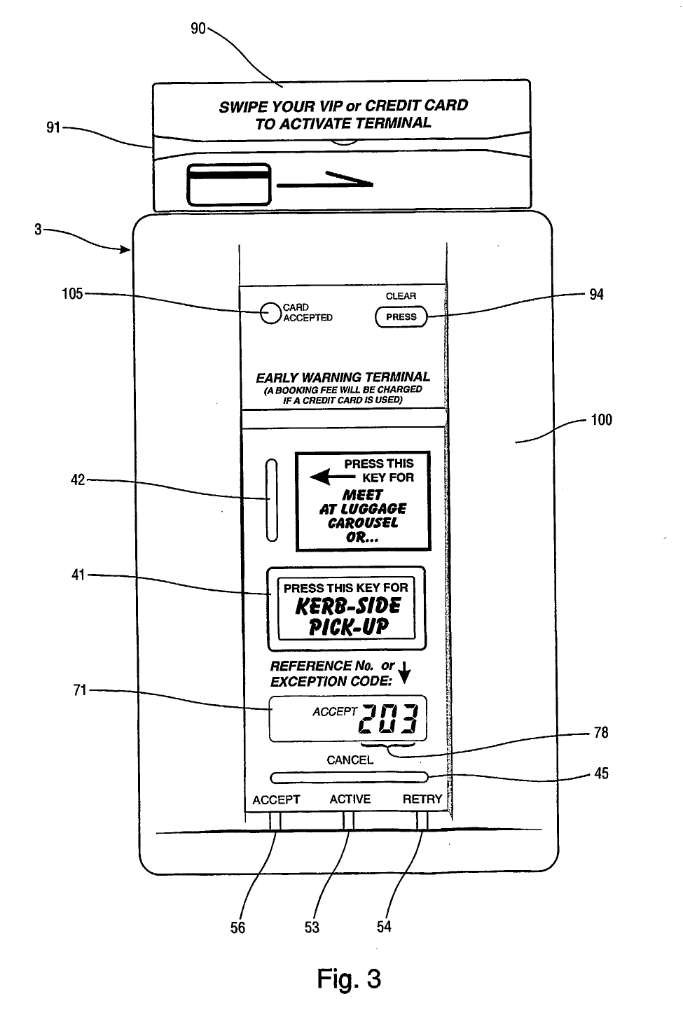

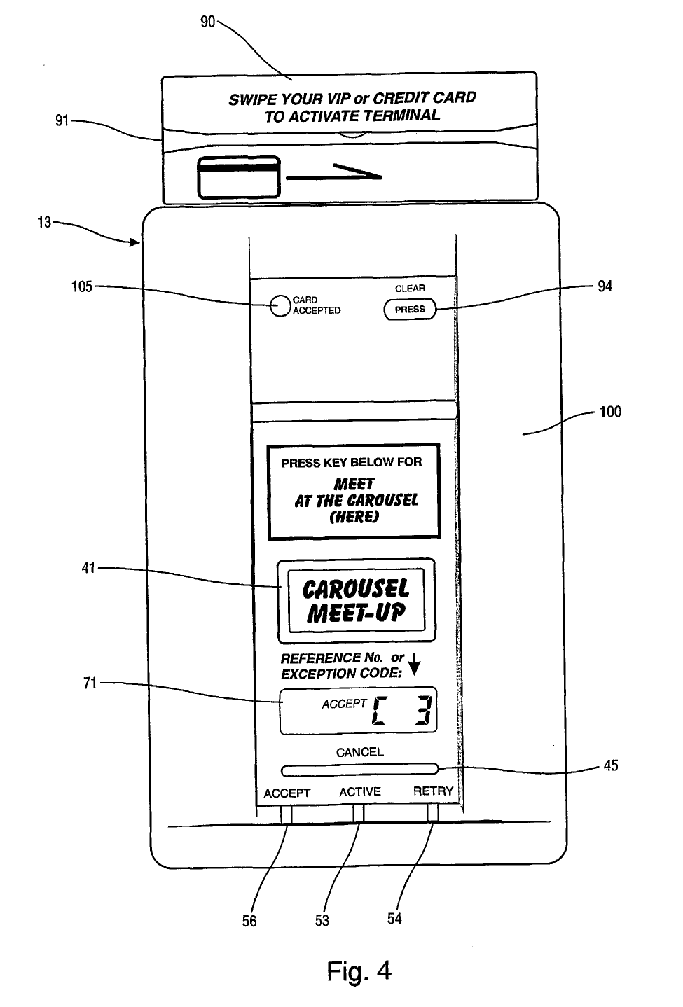

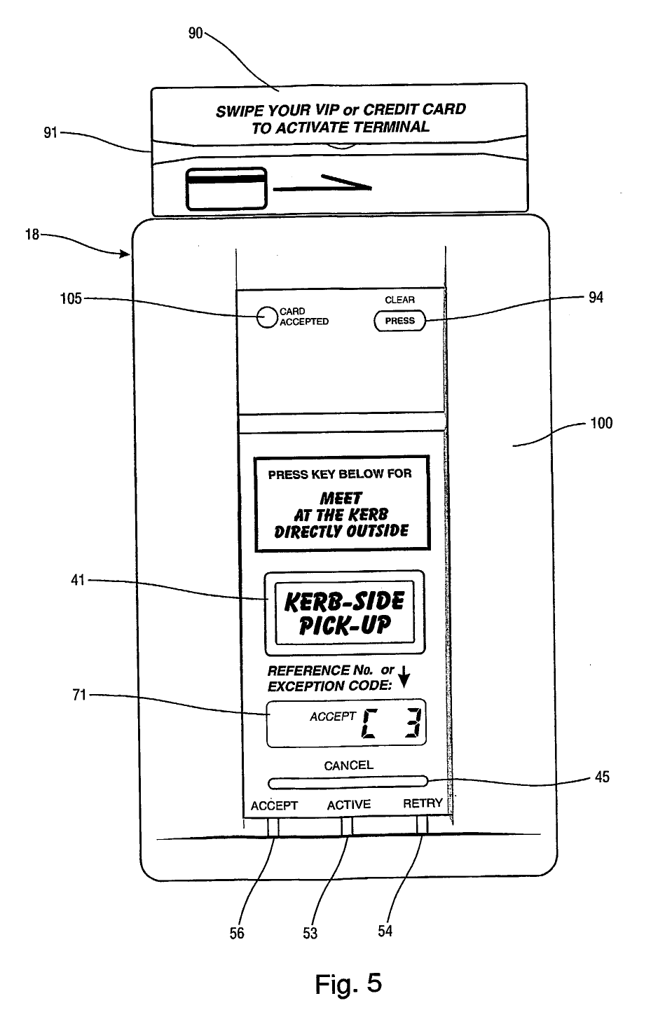

Referring now to FIG. 3 , FIG. 4, and FIG. 5 , there are shown respectively a first input station 3 , second input stations 13 at the carousels 11, and second input stations 18 at the exit gates 19.

The input stations 3, 13 and 18 have been disclosed in our international patent application PCT/AU95/00007 (WO 95/19679 ) published Jul. 20, 1995. The subject matter of that application is hereby incorporated by reference. These input stations 3, 13 and 18 are basically in accordance with the embodiment of FIG. 5 disclosed therein. The only exception is that in the embodiment of FIG. 5 therein there are provided three LED's 101, 102 and 103 which provide verification that up to three respective swipe cards can be read by the device. In the embodiments herein, only one swipe card is envisaged at any given time and therefore there is only one LED 105. Further, in the device shown in FIG. 5 of the aforementioned international patent specification, there are provided four call buttons 41, 42, 43 and 44. In this embodiment, there are provided only two call buttons 41, 42. Each input station 3, 13 and 18 is otherwise identical and appropriate circuit modifications are been made to provide for only the one LED 105 and the two call buttons 41 and 42. Such modifications can be made by a suitable electronics engineer without any inventive input, merely using normal day to day electronic engineering skills and therefore have not been detailed herein.

The stations shown in FIGS. 4 and 5 are identical to one another externally but internally each provide a different unique ID data code when transmitting so that the driver of the ground transportation will know which station the call is originating from, and therefore the location of the passenger. Each of the input stations 13 and 18 shown in FIGS. 4 and 5 is otherwise identical to that shown in FIG. 3 accept that in these two cases there is only one call button 41 and not a second call button 42.

Accordingly, the input stations which comprise the respective input stations 3, 13 or 18 shown in FIGS. 3, 4 and 5 are provided with a housing 100. The housing 100 has a card reader device 90 mounted thereto with an appropriate card swipe slot 91. As a passenger's card is swiped through the station, information is extracted from the card and stored in memory within the input station. A clear button 94 is provided to purge data read from a card passed through slot 91 in the event of errors in the swiping process. When a card is successfully swiped through the card swipe slot 91, as signified by illumination of “card accepted” LED 105, the passenger can then press an appropriate one of the buttons 41 or 42 to signify, in the case of FIG. 3 with button 41 a kerb side pick-up, or with button 42 a requirement to meet at the luggage carousel. In the case of FIG. 4, button 41 is pressed to signify the passenger is at a particular carousel and requires immediate rendezvous. In the case of FIG. 5 button 41 is pressed to indicate that the passenger is at a particular exit gate 19 and requires immediate rendezvous.

Each station 3 has LED's 53, 54 and 56 which indicate respectively, after operation of one of the call buttons 41 and 42, that the unit is “active” and communicating, that some transmission process was not completed and that the passenger should “retry”, and that the request for rendezvous has been made and has been “accepted” by the system.

Each of the input stations 3, 13 has an LCD display 71 as referred to previously, which can indicate a three digit reference number in area 78. This three digit number can be a booking number which can be noted. The driver can, in turn, have a display means which can be used within the vehicle to display the code number, so the passenger can readily see the number and distinguish the particular vehicle from one of many which may be at the kerb side. The display means may be portable and taken into the airport terminal and held by the driver so the passenger will know that the person assisting with the luggage is the driver of the vehicle booked for the passenger. The providing of the number in the display area 78 confirms that a vehicle is available when the passenger swipes the first input terminal 3. The same number will be logged in the system and will reappear when the card is swiped at further terminals. The exception code can be alpha/numeric code which, in the case of the card being swiped at the first input terminal tells the passenger that a vehicle is not currently but may be available by the time the passenger arrives at the carousel or the airport terminal gate, and that the passenger should retry at the respective input terminals at the carousel or airport terminal exit.

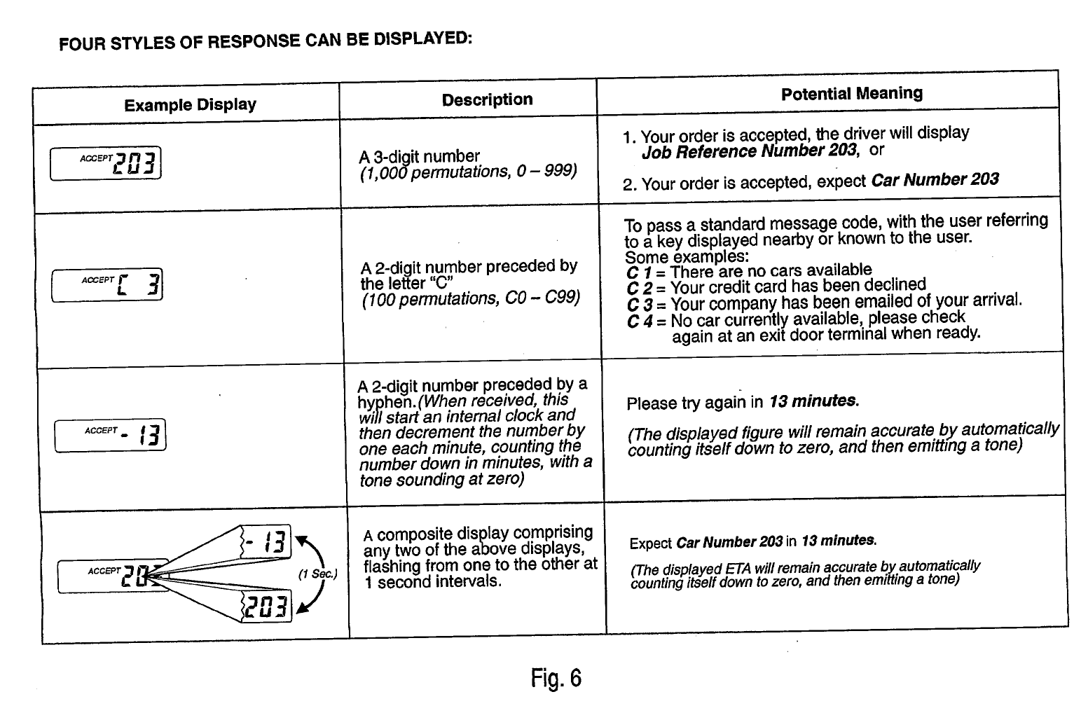

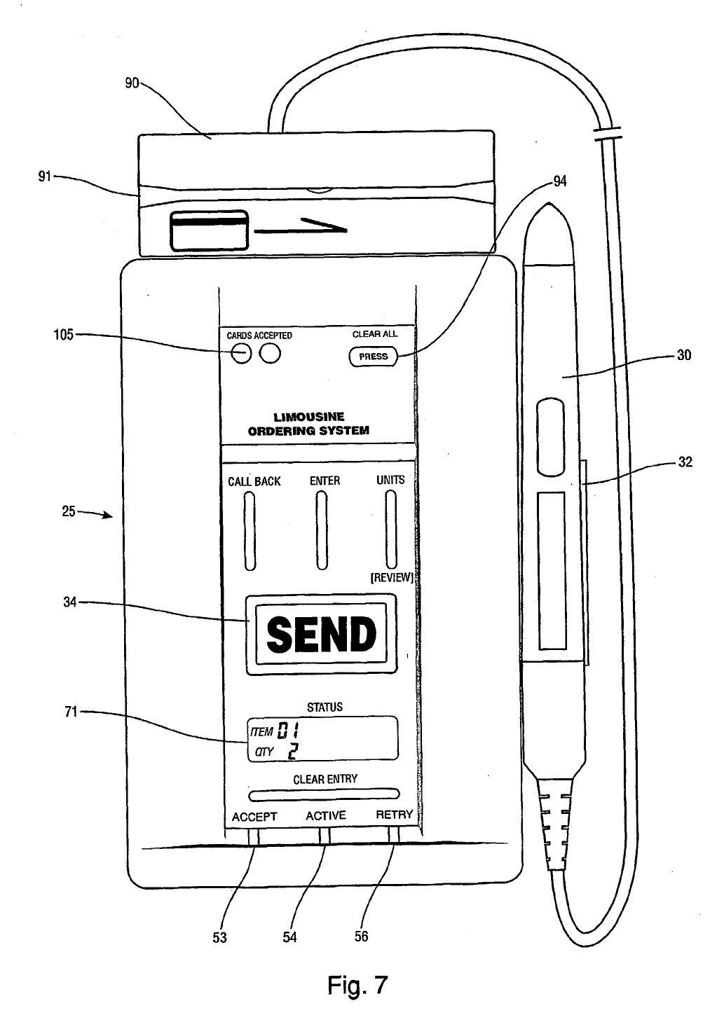

Referring now to FIG. 6 there is shown a chart of typical displays which can be provided in the display 71 in the display area. The chart shows number “203” and the word “ACCEPT”. The display of the word “ACCEPT” signifies that there has been a connection from the input station to the order placement system 15 and the order placement system has given a valid response. The number 203 represents a number that the passenger must memorise so that they can recognise a display carried by the driver or a display resident in the vehicle to distinguish the driver/vehicle from other drivers/vehicles. The number is a three digit number and has one thousand permutations. The next display is an alpha/numeric display “C3”. There also appears a display of the word “ACCEPT”. This signifies that the swipe of the card has been registered but because it is an alpha numeric display, there is some meaning associated with the display. A chart with the keys and their meaning may be placed near the input station means so that a passenger can decipher the message displayed. Typical displays may be C1—there is no car available. C2—your credit card has been declined. C3 your company has been e-mailed of your arrival. C4 no car/vehicle available, please check again at the second input station means 13 or 18. The numerical number in this display is a two digit number and assuming only one alpha character is displayed one hundred permutations are possible.

The next display is a numeric display such as number 13 which is preceded by a hyphen. Also displayed is the word “ACCEPT”. This display indicates that there is some delay in providing an answer from the dispatch computer system 17 and that the passenger should try again in the number of minutes representing the number displayed. Thus, the passenger should swipe again in thirteen minutes. The terminal will initiate operation of an internal clock and then decrement the number by one each minute counting the number down in minutes with a tone sounding at zero. The hyphen is the signal to the terminal to start the clock. The terminal can however still be used by other passengers during the count-down process.

The next display is a flashing alternating display. Here there is the display of -13 as one display and the other display is a numerical number such as 203. The display alternates between the two displays every one second or some other time period. The composite display indicates in the case of number 13 that it will be thirteen minutes before vehicle number 203 will arrive. The numeric display of 13 therefore represents the minutes anticipated before the vehicle will arrive. The passenger then has the possibility of accepting that request or cancelling the request for the vehicle.

Accordingly, the system described above provides for easy use by a passenger and also provides for easy and automated use by the order placement computer system 15. Drivers of ground transportation are readily alerted to the arrival of a passenger at the airport and the subsequent movement of the passenger either to the carousels 11 or the exit gates 19, and the system can signify to the driver whether the passenger requires luggage assistance at the carousel or is otherwise ready for collection at the kerb side adjacent an exit gate 19. Such system facilitates better use of ground transportation at airports and provides the passenger with a degree of comfort knowing that a dedicated ground transport vehicle can be obtained.

In the case where a non dedicated swipe card is used such as a normal credit card, a passenger is similarly provided with comfort that a driver can be either called directly to the kerb side or to the luggage carousel 11.

In the case where a dedicated swipe card is provided a charge for usage may be made to the ground transportation company directly. Alternatively, a charge may be made to the individual passenger depending on what prearrangements are made with the ground transportation company and the passenger concerning charging.

In the case of use of an ordinary credit card, the passenger can be debited directly to that credit card facility for the making of the call. The same card may subsequently be used by the ground transportation company for charging for the actual transport which is then made. A check can be made at that time, before accepting the order, that the card is not stolen, and further a pre-authorisation for the anticipated fare may be undertaken, thereby providing information to the vehicle driver that he/she will be paid for the services rendered.

The system also enables prearranged functions to be initiated on swiping of a card through one of the input stations 3, 13, 18. For example, prearrangements may be made to fax, e-mail or voice message to a particular location. In this way, when the passenger arrives at the airport terminal, information can be relayed from the order placement computer 15, not only to the ground transportation driver but also to another location to alert persons such as a wife at home or the office as to the arrival of the passenger at the airport and to expect the passenger shortly.

In another embodiment, drivers of ground transportation can have their own swipe cards and these can be swiped through a dedicated input station 21 at the airport holding area 7 to signify to the system that the particular vehicle is available for service in this system. The input station 21 are similar to the input stations 3, 13, and 18. These input stations however, have only one button to be pressed by the driver. Thus, on a driver swiping his card through the input station 21, he can proceed to press the one button to log into the system. This creates a pool of vehicles which can be utilised for passengers who have not made pre-booked arrangements. The driver will then be given a display on display 71 of the number of vehicles already ahead in the queue. In the case of pre-booked arrangements, the ground transportation driver will be at the airport holding area 7 at an expected time of arrival of the passenger and thus will normally be waiting for a call to alert the ground transportation driver to the requirement to make rendezvous. If the passenger arrives early ahead of time for the prearranged ground transportation, the passenger may take one of the other vehicles in the pool of vehicles. The system can also be arranged to sense the early arrival of the passenger and to make a call to the prearranged transportation driver to say that the passenger has taken alternative transport. Further, a driver can elect to swipe his card through, on input station 18 at the airport terminal, after dropping off a departing passenger. This procedure will then cause a display as to the position in the queue, as if swiping at the holding area input station 21.

It should be appreciated that the above system has many applications and is not confined to the particular example described above for use at airports.

It should also be appreciated that many modifications may be made to the system without departing from the scope thereof. For example, each user card which is issued to passengers could be provided with information indicating the type of ground transportation required. Thus, it may not be necessary to have prearranged ground transportation provided i.e. type of vehicle. The card itself will contain that information and can be relayed to particular ground transportation at the airport holding area 7. Further, instead of use of a swipe card there may be a keypad provided on the device and a suitable display. The passenger can then enter identification information into the memory in the input station using the keypad and observing the display to note correctness of entry. Further, a bar code reader could be provided for reading a bar code on a user card to thereby input the identification information.

In a particularly preferred embodiment, at least one third input station 25 is provided at an appropriate point in an airport at a first location to allow a user to place an order for ground transport at their flight destination before they board their flight to an airport at a second location. Typically, third input stations 25 would be provided at all airports where there are suitable facilities. It is particularly preferred that the third input station 25 is located in a lounge maintained by an airline which is reserved for airline club members, as such persons are more likely to be users of the present system. However, if appropriate, third input stations 25 can be placed in the respective departure gates of each airport.

The third input stations 25 are linked to the order placement system 15 in the same manner as the first and second input stations and allow a user to place an order and for that order to be relayed via a dispatch computer system 17 if necessary. In this manner, the user can place an advance order for ground transport before leaving their point of departure to thereby improve their prospects of the appropriate ground transport being available when they arrive at their destination and hence to make their desire to rendezvous at a future time known to another person.

To facilitate operation of this aspect of the system, a person uses the system preferably to register a user profile. The user profile is then used subsequently to facilitate the ordering of ground transport using the third input station 25. A user need not have a profile in order to operate the system, however, the user will not have access to the full range of functions if they do not register a profile.

The user's profile is stored in a database associated with order placement system 15 from which relevant items of data can be retrieved as necessary. A typical user profile would consist of the following items:

| ITEM | EXPLANATION |
|---|---|
| My office | The user's office address |
| My home | The user's home address |
| Profile #1 | A first address nominated by |
| | the user (e.g. a branch |
| | office) |
| Profile #2 | A second address nominated |
| | by the user (e.g. the user's |
| | club) |
| Office e-mail | An e-mail address nominated |
| | by the user to receive |
| | various messages |
| My mobile telephone number | A number used to receive |
| | messages by SMS messages |
| Profile recipient #1 | Another phone number used |
| | for SMS messaging (e.g. |
| | spouse's mobile) |
| Profile recipient #2 | A further address nominated |
| | for SMS messaging (e.g. |
| | bosses mobile) |
| Automatic messaging | E-mail address used for |
| | various purposes (e.g. head |
| | office records, personal |
| | tracking etc) |
| Settlement profile | Indicates the manner in |
| | which a settlement of the |
| | ground transport cost will |
| | be arranged (e.g. in the |
| | vehicle account etc) |

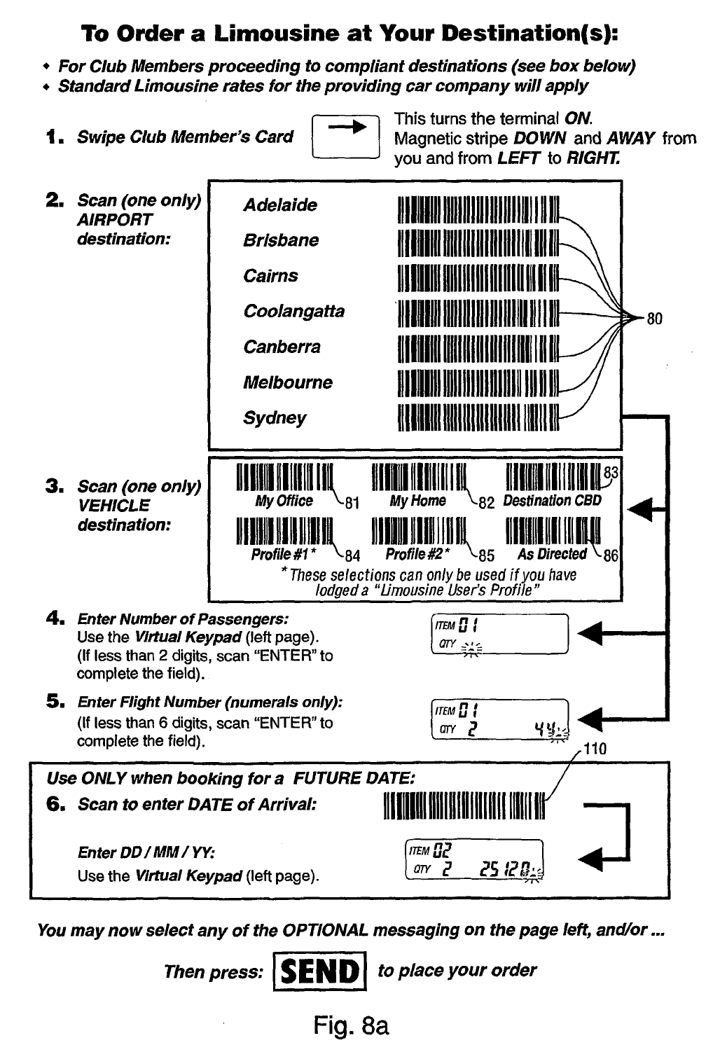

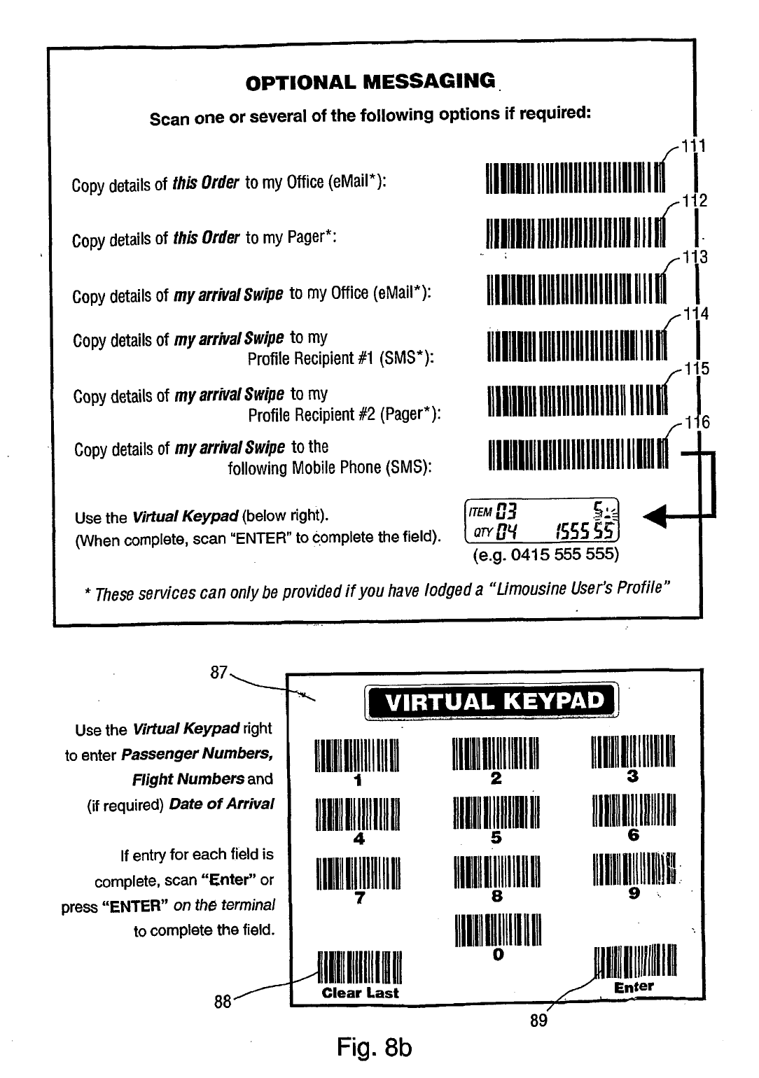

In order to place an order using the third input station 25 the user swipes a user card through the swipe slot 91 of the third input station 25 which is located at the airport from which the user is departing. The third input station 25 includes a barcode reader in the form of a barcode scanner wand 30 which is placed within barcode scanner bracket 32 when not in use. The user uses the barcode scanner 30 to scan various barcodes located in an ordering manual illustrated in FIGS. 8a and 8bin order to place an order for ground transport.

The ordering manual illustrated in FIGS. 8a and 8b is exemplary only and it will be apparent that various modifications may be made to it to accommodate the services which are available. The ordering manual illustrated in FIGS. 8a and 8b both guides the user through the ordering process and contains the various barcodes which are necessary to enable the user to enter the necessary information.

Having swiped their card, the user next selects a destination airport which has a participating ground transport system by selecting an appropriate one of a plurality of destination barcodes 80 and scanning it with barcode scanner 30.

Next, the user scans a barcode 81, 82, 83, 84, 85, 86 corresponding to the destination to which they want to travel to using ground transport. Various of these barcodes correspond to addresses previously registered with a user's profile. Specifically, barcode 81 corresponds to the user's office address, barcode 82 corresponds to the user's home address, barcode 84 corresponds to the first address indicated by profile #1 and barcode 85 corresponds to the second address indicated by profile #2.

The other barcodes provide means for a non-registered user to specify their intended destination or for a registered user to specify a destination which isn't in their profile. Barcode 83 indicates that the user's intended destination is the CBD and barcode 86 indicates that the user will direct the driver of the ground transport to an appropriate destination.

If the user uses an address located in their profile, this can retrieved from the database by the order placement system and relayed as appropriate to the transport driver or the dispatch computer system 17 so that it can then, in turn, be relayed to the grounds transport driver once the order has been placed.

Further ordering steps include the user specifying the number of persons to be travelling. The number of persons travelling are indicated by LCD display 71. To specify a number of persons, the user scans an appropriate number using virtual keypad 87. If the user makes an error by scanning an inappropriate number, the user can use clear button 88 to clear the entered number. When the user has completed entering the number of passengers, the user scans enter button 89 to enter the passenger number.

The user is then required to enter a flight number. As it is envisaged that the user will be located in a lounge associated with a particular airline, the user need only enter the number of the flight and not the prefix to that number which is commonly used to specify which airline the flight number applies to (e.g. QF for Qantas) as the number itself is unique to a particular flight regardless of the airline company.

If the user wants to book for a future date they can optionally use the future date barcode 110 to indicate that the booking relates to a future date and specify a date by using the scanner 30 to scan numbers of the virtual keypad.

The user can then choose for optional messages to be sent relating to their booking or their arrival at the destination airport by scanning messaging. Scanning barcode 111 copies details of the order to the user's office e-mail identified in the user's profile so that said user's office can have a copy of the order. This may be used to keep track of use of the system by a business, for example to reconcile orders against invoices received from a ground transport company. Scanning barcode 112 indicates that the order is to be copied to the user's pager or mobile phone. This allows the user to readily obtain a copy of the order which they can store on their pager or phone and retrieve if necessary when they reach their destination thereby keeping track of their order number. Barcodes 113, 114, 115 and 116 indicate various functions which are to be completed when the user's arrival swipe at a first input station 3 is registered. Barcode 113 specifies copying details of the user's arrival to their office by e-mail. Barcode 114 indicates that details of the user's arrival should be copied to profile recipient #1 by SMS message. Barcode 115 provides a similar message to profile recipient #2 by pager.

Barcode 116 allows details of arrival to be copied to a specified mobile phone which may be entered by means of a virtual keypad 87. Thus, for example the user could arrange for a message to be copied to a specified business associate so that associate can have an expectation of the user's arrival from the airport. For example, the user and the business associate may have agreed to meet one hour after the user arrives at the airport.

Once all of the ordering information has been entered into the third input station 25, the user presses the send button 34 in order to transmit the order request to the order placement computer system 15. The order placement computer system is able to access the user's profile as well as scheduling data for the airline in order to construct the order by reference to the expected arrival time of the flight specified by the user. Once the order is accepted, a reference number is provided on the screen. As explained, the reference number can also be copied by SMS message to the user's mobile phone at the user's option. The reference number can then be used when the user arrives at their destination in the manner in which a reference number generated by the first input station is used.

If the order cannot be accepted, an exception code will be displayed explaining why the order cannot be accepted.

An associated fax machine located in the airline lounge is used in a particularly preferred embodiment in order to receive a fax docket confirming details of the order and the reference number so that the user has a hard copy of the order and reference number which they can refer to as necessary. The fax docket can be computer generated by the order placement system 15 using appropriate software and transmitted to the associated fax machine as soon as the order has been generated. Alternatively, a message confirming details of the order can be sent by any other convenient means, such as by e-mail to a mobile terminal carried by the passenger.

If the associated fax machine is busy, the computer software located in the order placement system 15 uses redial queuing to ensure that the docket is relayed by fax as soon as possible.

The virtual keypad 87 may be modified to be a virtual alphanumeric keypad if it is necessary to enter letters of the alphabet. For example, to enter the flight number prefix which identifies the airline.

In the examples given above, a swipe of a passenger's card at the input station 18 at the exit gate, enables a driver to be informed that the passenger is at the kerbside. Accordingly, the driver does not have to leave the vehicle to enter the terminal, and therefore this will aid in lowering vehicle congestion at the exit gates. Moreover, this also alleviates need for the passenger to walk a considerable distance to the airport holding area where the vehicle would otherwise be parked.

These and other modifications may be made without departing from the ambit of the invention the nature of which is to be determined from the aforegoing description.

1. A face-to-face rendezvous method enabling one person to announce the desire to rendezvous with another person so that said another person can be alerted to the desire and then make face-to-face contact,
said method including inputting information identifying said one person to a first input station, storing that information in a store in said first input station, activating said first input station to retrieve that stored information and to transmit that information to a receiving station together with first input station ID data, having said another person alerted to that information and the ID data by said receiving station thereby signifying the desire to rendezvous and the location of the one person by association of the ID data with known input station location, providing an acknowledging signal to the first input station so that said one person can be made aware that the information has been received, having a second input station in closer proximity than the first input station to a pre-established point of rendezvous, inputting information by said one person identifying presence of said one person at said second station, said second station transmitting that information to said receiving station together with second input station ID data so said another person can be advised of said one person at said second input stations the ID data from the particular second input station identifying the location of the one person by association of the second input station ID data with known input station location, and
finally, having said another person then make face-to-face contact with said one person.

2. A method as claimed in claim 1 wherein there are a plurality of second input stations in close proximity than the first input station to the point of rendezvous.

3. A method as claimed in claim 1 wherein said second input station also contains a store for storing said information and wherein said information can be retrieved from said store for transmitting to said receiving station.

4. A method as claimed in claim 2 wherein there is included a third input station located at a location remote from where said first input station and said second input station are located, said method including a user inputting information identifying said one person and indicating their likely future arrival at a first or second input station thereby signifying the desire of the one person to rendezvous at a future time, alerting said another person to signify the desire to rendezvous at a future time to thereby prepare said another person to rendezvous at said future time, and providing an acknowledging signal to the third input station so that said one person can be made aware that said another person has been alerted.

5. A face-to-face rendezvous system enabling one person to announce the desire to rendezvous with another person so said another person can be alerted to that desire and then make face-to-face contact,
said system including a first input station located at a point where said one person can make said announcement, and a receiving station which can receive said announcement from said first station and signal to said another person the desire to rendezvous, said first input station having input means by which said one person can input information identifying presence of said one person at said input station, and store means for storing that information, said first input station also having store retrieving means for retrieving that information and transmitting means for transmitting that information together with input station ID data to said receiving station,
said receiving station having means for receiving said information and said ID data via a communication medium connecting said first input station and said receiving station, and further means for alerting said another person to the receipt of said information at the receiving station, and acknowledging means for generating and transmitting an acknowledging signal to said first input station where it can be used to inform said one person of receipt of that information the ID data permitting the location of the person to be determined by association of the ID data with the known input station location said system also having a second input station in closer proximity than the first station to a pre-established point of rendezvous so that when the first person is at said second input station, said one person will be able to input information signifying presence of said one person at said second input station so that said information can be dispatched therefrom to said another person, thereby signaling said another person that said one person is ready for rendezvous and at the location of said second input station.

6. A system as claimed in claim 5 wherein said receiving station is an intermediary to transmitting the information to another person.

7. A system as claimed in claim 5 wherein said information is processed at said receiving station to identify said one person from the received information and to check a profile for that one person to determine particular preference or pre-arranged rendezvous requirements for said one person and to, in turn, act in respect thereto to effect those preferences or requirements.

8. A system as claimed in claim 5 wherein there is included a third input station located at a further location remote from where said first input station and said second input station are located, whereby said one person can input information identifying said one person and indicating their likely future arrival at said first or second location thereby signifying the desire of the one person to rendezvous at said future time, alerting said another person to signify the desire to rendezvous at a future time to thereby prepare said another person to rendezvous at said future time, and providing an acknowledging signal to the third input station so that said one person can be made aware that said another person has been alerted.

9. A system as claimed in claim 5 including a further input station at a point of departure of said one person, said point of departure being a departure location from which said one person is to depart on a journey effected by a transport vehicle before arriving at an arrival location, said first and said second input stations being at said arrival location, and wherein communication means is used to communicate input information entered by said one person into said further input station into said system, thereby alerting said another person to the presence of said one person at said further input station.

10. A system as claimed in claim 5 including an input station for said another person to input information signifying availability of said another person to make rendezvous.

11. A system as claimed in claim 10 wherein said input station is a different input station to said first input station.

12. A system as claimed in claim 10 wherein said input station is said second input station.

13. A system as claimed in claim 5 including data entering means at any one of said first input station or said second input station by which messages may be input by said one person, said messages being additional to the information input by said one person to signal to said another person the desire to rendezvous.
